(19) United States
(12) Patent Application Publication
(10) Pub. No.: US 2012/0090382 A1
(43) Pub. Date: Apr. 19, 2012

(54) DEVICE AND METHOD FOR ANALYSING GAS AND ASSOCIATED MEASUREMENT STATION

(75) Inventors: Arnaud Favre, Annecy (FR); Erwan Godot, Annecy (FR); Bertrant Bellet, Chambery (FR)

(73) Assignee: ADIXEN VACUUM PRODUCTS, Annecy (FR)

(21) Appl. No.: 13/377,659

(22) PCT Filed: Jun. 11, 2010
(86) PCT No.: PCT/EP10/58251

§ 371 Date: Dec. 12, 2011

(30) Foreign Application Priority Data
Jun. 12, 2009 (FR) 0902850

(51) Int. Cl. G01N 27/12

(52) U.S. Cl. 73/31.06

(57) ABSTRACT

The invention relates to a station for measuring gaseous pollution in a transport enclosure of semiconductor substrates comprising a gas analysis device for determining the concentration of the gas to be analysed, said analysis device including: a diluting unit (3) configured to dilute a flow of gas to be analysed (Q) according to a dilution coefficient (D), and an analysis unit (5) communicating with the diluting unit (3) via a sampling pipe (7) in order to sample a flow of diluted gas (Qa) by pumping, and comprising at least one processing means for: analysing the sampled flow of diluted gas (Qa), and determining the concentration (C) of the gas flow to be analysed (Q) according to said analysed flow of diluted gas (Qa) and the dilution coefficient (D). The invention further relates to an associated gas analysis method.

The present invention relates to a device and a method for analyzing gas. The invention also relates to an associated measurement station.

The known gas analysis devices sample a specific gas flow to be analyzed, for example at the output of a transport enclosure for the conveying and atmospheric storage of semiconductor substrates or again at the input or at the output of a filter for detecting the presence of traces of gas of the order of one “ppb” (Parts Per Billion).

In a known way, an analysis device comprises a sampling pump for conveying a sampled flow of gas to an analysis unit or analyzer.

These analysis devices have an operating range and an uncertainty fixed by the analysis technology as well as by the calibration means used. Moreover, these analysis devices function correctly only for respective ranges of concentration of the gas to be analyzed. Thus, each analysis device has an optimum operating range depending on the nature of the gas to be analyzed.

This has the disadvantage of requiring several analysis devices depending on the desired measurement ranges. Problems of cost and of overall dimensions derive from this disadvantage. Moreover, this implies knowing the concentration range of the gasses very accurately in order to optimize the choice of the analysis device.

Moreover, for a given range of concentration, the analysis devices can generally analyze different gas flows by multiplexing, by the intermediary of one or more multi-way valves. For example, the analysis device can carry out the analysis of a first and of a second gas flow, the first gas flow being of higher concentration than the second.

However, if the analysis unit firstly receives the first gas flow of higher concentration, the analysis unit and the sampling pump can be polluted, for example because of clogging in the pump or of the degassing of compounds accumulated in the pump which then pollute the gas flow to be analyzed. This pollution can cause a reduction in the quality of the analysis.

Moreover, a relatively long response time can be necessary in order to eliminate the residual gasses before carrying out the analysis of the second gas flow.

A purpose of the invention is therefore to propose a gas analysis device with optimized performance having an extended operating range, a reduced response time and of which the problems of pollution due to analyses of gasses having different ranges of concentration are reduced.

For this purpose, the invention relates to a station for measuring gaseous contamination in a transport enclosure for semiconductor substrates comprising a gas analysis device for determining the concentration of the gas to be analyzed, said analysis device comprising:
a diluting unit configured to dilute a flow of gas to be analyzed according to a dilution coefficient, and
an analysis unit communicating with the diluting unit via a sampling pipe in order to sample a flow of diluted gas by pumping, and comprising at least one processing means for:
   analyzing the sampled flow of diluted gas, and
   determining the concentration of the flow of gas to be analyzed from said analyzed flow of diluted gas and from the dilution coefficient.

By varying the dilution of the flow of gas to be analyzed, a constant flow and relatively low concentrations are maintained at the level of the analysis unit, which makes it possible to use the same analysis unit for several gasses having different ranges of concentration.

Moreover, an improvement of the response time of the unit is observed since a shorter waiting time is necessary for eliminating the residual gas in the sampling piping in comparison with a device analyzing a pure undiluted gas flow.

Such an analysis device furthermore makes it possible to reduce the risks of contamination of the analysis unit and of the sampling piping because the gas flows passing through them are always diluted.

The station for measuring the gaseous contamination of a transport enclosure for semiconductor substrates comprises a gas analysis device which can furthermore comprise one or more of the following features, taken separately or in combination:
the analysis unit comprises a gas analyzer which measures concentrations of the order of one ppb (parts per billion),
the diluting unit is connected as a branch with respect to said pipe,
the diluting unit comprises a plurality of dilution channels connected as branches with respect to said pipe, each dilution channel being respectively associated with a dilution coefficient,
each dilution channel has:
   a means of injection of a flow of neutral gas into said pipe in order to dilute said flow of gas to be analyzed, and
   a means of pumping a flow of diluted gas in order to extract it from said pipe, in such a way as to maintain a constant flow in said pipe,
each dilution channel is respectively associated with the dilution of a flow of gas to be analyzed,
at least two dilution channels are associated for the dilution of a flow of gas to be analyzed,
said analysis device is configured to analyze, on the one hand, a flow of gas at the input of a filter and, on the other hand, a flow of gas at the output of the filter.

The invention also relates to a gas analysis method for determining the concentration of the gas to be analyzed comprising the following steps:
a dilution coefficient is determined,
a predetermined flow of neutral gas is injected and a flow of diluted gas is pumped, in such a way as to dilute a flow of gas to be analyzed,
a flow of diluted gas is sampled by pumping,
the sampled flow of diluted gas is analyzed,
the concentration of the flow of gas to be analyzed is determined from said analyzed flow of diluted gas and from the dilution coefficient.

Said analysis method can comprise a preliminary step in which the dilution coefficient is determined as a function of the maximum value of concentration of the range of concentration of the gas to be analyzed.

Other features and advantages of the invention will emerge from the following description, given by way of example and not limitative in nature, with reference to the appended drawings in which:

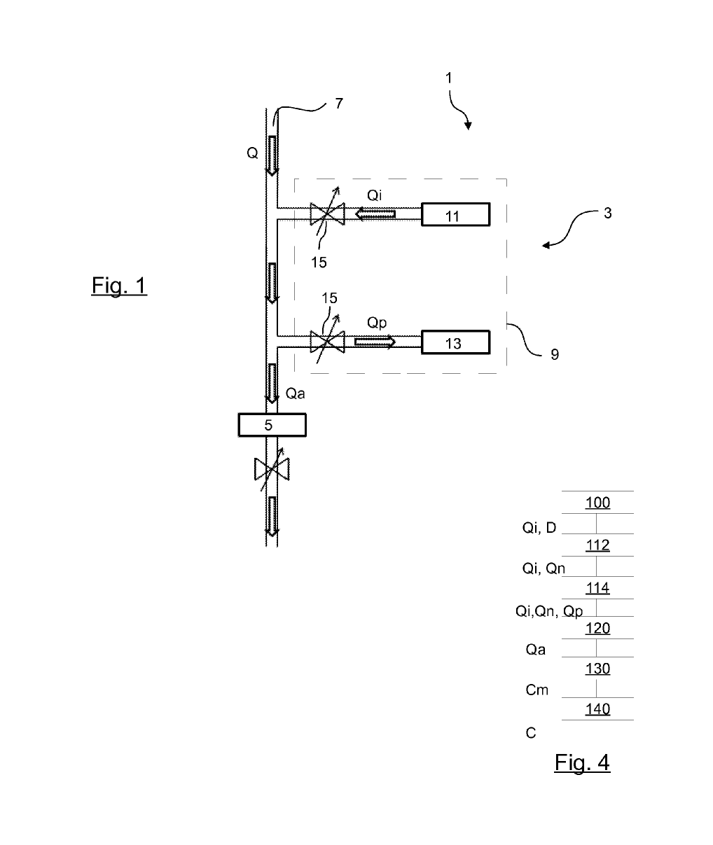

FIG. 1 shows a gas analysis device according to a first embodiment,

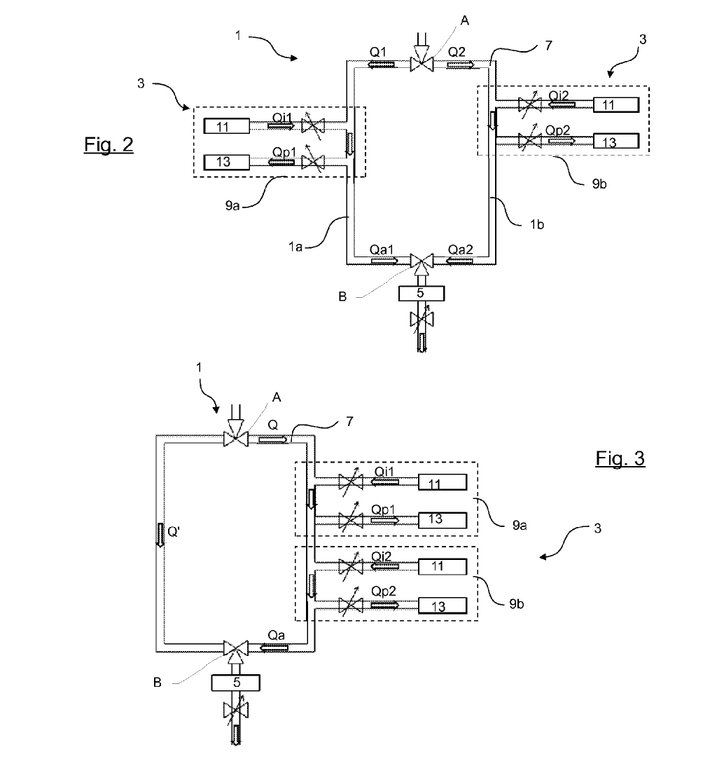

FIG. 2 shows a gas analysis device according to a second embodiment,

FIG. 3 shows a gas analysis device according to a third embodiment, and

FIG. 4 shows the different steps of a method for analyzing gas.

In these figures, the substantially identical elements bear the same references.

FIG. 1 shows an analysis device 1 for determining the concentration of the gas to be analyzed, for example ammonia gas having a concentration of the order of 5000 ppb. More precisely, in a gaseous mixture, such an analysis device 1 can determine the concentration of a given gas from a flow of gas Q, even in low proportions. The value of the flow of gas Q is ascertained by the following equation (1).

Q=S*P (where Q=gas flow, S=pumping speed, P=pressure). (1)

By way of example, the analysis device 1 comprises an analysis unit 5 having an operating range of 0 to 50 ppb. Analysis of the ammonia gas for example therefore requires the gas to be diluted by at least one hundred times.

In order to do this, the analysis device 1 comprises a unit 3 for diluting the flow of gas to be analyzed Q according to a dilution coefficient D communicating with the analysis device 5 via a sampling pipe 7.

In order to sample a flow of diluted gas for analysis Qa, a pump, which is not shown, is provided, which can either be connected to the pipe 7, integrated with the analysis unit 5 or disposed upstream or downstream of the analysis unit 5. The flow of diluted gas sampled for analysis Qa is imposed by the analysis unit 5.

The analysis unit 5 comprises at least a processing means for:
analyzing the sampled flow of diluted gas Qa, and
determining the concentration of the flow of gas to be analyzed Q from the analyzed flow of diluted gas Qa and from the dilution coefficient D.

For example, the analysis unit 5 comprises a gas analyzer (not shown) for measuring the concentration Cm (FIG. 4) of the sampled flow of diluted gas Qa.

In order to carry out an analysis in real time, that is to say in a very short period of time and in a way that is sufficiently sensitive for detecting very low levels of gaseous contamination in the trace state (of the order of one ppb), one possibility is to use a gas analyzer in which the mobility of the ions is measured, for example according to the IMS (Ion Mobility Spectrometer) instrumentation principle or according to the IAMS (Ion Attachment Mass Spectrometer) technology.

Moreover, the analysis unit 5 comprises a means (not shown) for calculating the concentration C of the gas flow to be analyzed Q by multiplying the measured concentration Cm of the sampled flow of diluted gas Qa by the dilution coefficient D.

This dilution coefficient D is determined such that the sampled flow of diluted gas Qa analyzed by the analysis unit 5 corresponds to the operating range of the analysis unit 5. In order to do this, the maximum concentration value of the range of concentration of the gas to be analyzed that it is possible to have is determined and the dilution coefficient D is fixed according to this value.

It is therefore understood that the dilution coefficient D can be adapted for each range of concentration of the gas to be analyzed. Thus, for several gasses to be analyzed with different ranges of concentration, the dilution varies in such a way that one and the same analysis unit can be used.

Moreover, only diluted gasses pass through the pump of the analysis unit 5 and through the analysis unit 5, which reduces the risk of degrading the measurement quality of the analysis unit. The dilution furthermore makes it possible to avoid a critical contamination of the analysis unit 5 because relatively low concentration values are maintained in this analysis unit 5.

With reference to FIGS. 1 to 3, the diluting unit 3 can have one or more dilution channels 9 branch connected with respect to the pipe 7. These dilution channels 9 are shown in boxes drawn in dotted lines in FIGS. 1 to 3.

In the example shown in FIG. 1, the diluting unit 3 comprises a single dilution channel 9. This dilution channel 9 comprises two branches connected to the pipe 7.

The first branch has a means 11 of injecting a flow of neutral gas Qi into the pipe 7 in order to dilute the flow of gas to be analyzed Q. The term “neutral gas” is understood here to be an inert gas such as nitrogen. The value of the injected flow of neutral gas Qi is limited by the flow available from the installation where the device is set up. The value of the flow of neutral gas Qi is chosen judiciously to be as large as possible whilst taking account of the operating cost and of the size of the installation. Moreover, the analyzer is disturbed if too much flow is injected close to the analyzer.

The second branch has a pumping means 13 which makes it possible to draw off the flow of gas to be analyzed Q from the pipe 7. The value of the flow of gas to be analyzed Q is derived from the dilution coefficient D and from the flow of neutral gas Qi according to the equation (2).

$$Q = \frac{Qi}{( D - 1 )} \qquad ( 2 )$$

The pumping means 13 makes it possible, on the other hand, to extract a flow of diluted gas Qp from the pipe 7 in such a way as to maintain a constant flow in the pipe 7.

The pumped flow of diluted gas Qp is then calculated using the equation (3).

Q=−(Qi+Qp+Qa) (3)

By way of example, for an injected flow of neutral gas Qi of 4.5 slm (slm=“Standard Liter per Minute”, that is to say the flow in L.min⁻¹; 1 slm=1.6883 Pa.m³.s⁻¹) for a pumped flow of diluted gas Qp of −4.5 slm and for a sampled flow of gas to be analyzed Qa of 0.5 slm, the flow of gas to be analyzed Q is equal to 0.5 slm according to the equation (3).

As regards the dilution coefficient D, this is equal to 10 according to the equation (2).

The analysis device 1 can furthermore comprise flow meters 15 making it possible to regulate the injected flow of neutral gas Qi, the flow of pumped diluted gas Qp and the flow of diluted gas sampled for analysis Qa respectively.

It is possible to provide automatic control of these flow meters 15 by control means (not shown) for controlling and varying these different flows.

As a variant, these flows can be determined by microleaks.

FIG. 2 shows a second embodiment in which the diluting unit 3 comprises a first dilution channel 9a on a first branch 1a of the analysis device 1, and a second dilution channel 9b on a second branch 1b of the analysis device 1, the two dilution channels 9a and 9b being branch connected with respect to the pipe 7.

As seen in FIG. 2, the two branches 1a and 1b are connected in parallel, starting from a common point A for the introduction of the flow of gas to be analyzed Q1 or Q2 and joining each other again at a common point B at the input of the analysis unit 5.

For this purpose, the analysis device 1 comprises:
first multiway valves 17a for directing the flow of gas to be analyzed Q1 or Q2 into the corresponding branch according to the analysis to be carried out, and
second multiway valves 17b to make it possible to sample the flow of diluted gas to be analyzed Qa1 or Qa2 from the first branch 1a or the second branch 1b, according to the analysis to be carried out.

Each dilution channel 9a, 9b can be configured for diluting a flow of gas to be analyzed according to a first associated dilution coefficient D1 and a second associated dilution coefficient D2 respectively. In this case, for each gas to be analyzed, the associated dilution channel 9a or 9b is used and the same analysis unit 5 is used. In order to determine the concentration of the flow of gas to be analyzed Q, the dilution coefficient D1 or D2 associated with the dilution channel 9a or 9b used is therefore taken into account.

By way of example, the analysis unit 5 imposes a diluted flow to be analyzed of Qa=0.3 slm.

When the first dilution channel 9a is associated with a first range of concentration of gas to be analyzed, a first dilution coefficient D1 is determined on the basis of the maximum concentration of this range of concentration, for example D1=10.

The flow of neutral gas Qi1 to be injected for the dilution is imposed, for example Qi1=2.7 slm.

The value of the flow Q1 is derived from the first dilution coefficient D1 and from the flow of neutral gas Qi1 (equation (2)), in this example Q1=0.3 slm.

Then the value of the diluted flow to be pumped Qp1 in order to dilute the flow of gas Q1 is calculated (equation (3)), in this example Qp1=−2.7 slm.

Once the flow of diluted sampled gas Qa1 has been analyzed, the concentration of the flow of gas to be analyzed Q1 is determined from the first dilution coefficient D1.

Similarly, when the second dilution channel 9b is associated with a second range of concentration, a second dilution coefficient D2 is determined from the maximum concentration of this range of concentration, for example D2=20.

The flow of neutral gas to be injected Qi2 for the dilution is imposed, for example Qi2=5.4 slm.

The value of the flow Q2 is derived from the second dilution coefficient D2 and from the flow of neutral gas Qi2 (equation (2)), in this example Q2=0.3 slm.

Then the value of the diluted flow to be pumped Qp2 for diluting the flow of gas Q2 is calculated (equation (3)), in this example Qp2=−5.4 slm.

Once the flow of diluted sampled gas Qa2 has been analyzed, the concentration of the gas to be analyzed Q2 is determined from the second dilution coefficient D2.

As a variant, it is possible to provide for each gas to be analyzed, more precisely for each range of concentration, to be associated with one or more dilution channels.

According to a third embodiment shown in FIG. 3, it is possible to associate all of the dilution channels in branch connection with respect to the pipe 7, for example the first dilution channel 9a and the second dilution channel 9b, for a given range of gas concentration. In this case, the dilution channels are connected in series on a common branch, in this case the branch 1b of the analysis device 1.

Moreover, the analysis device 1 comprises a bypass branch 1a having no dilution channels for the flow of gas to be analyzed Q when the latter must not be diluted.

For example, if the range of concentration of the gas is not known, both of the dilution channels 9a and 9b are associated from the start and, if the concentration Cm of the sampled flow of diluted gas Qa cannot be determined because it is too low, the flow of gas Q is then directed into the bypass branch comprising no dilution channels.

In this case, the first valves 17a make it possible to distribute the flow of gas Q or Q′ into the corresponding branch 1a or 1b, and the second valves 17b make it possible to sample the flow Q′ or the diluted flow Qa for analysis.

When several dilution channels are used in series, an overall dilution coefficient D is determined, equal to the product of the dilution coefficients of each dilution channel used, according to equation (3).

$$D = {\prod }_{i} Di \qquad ( 4 )$$

For example it is possible, for a third range of concentration of gas to be analyzed, to associate both dilution channels 9a and 9b in order to dilute the gas to be analyzed Q. In this case, according to the equation (4), the overall dilution coefficient D is the product of the first D1 and second D2 dilution coefficients.

Moreover, according to this third embodiment the different dilution coefficients are equal (equation 5).

Di=Dj (for all values i,j) (5)

Consequently, it is possible to determine the value of a dilution coefficient Di from the overall dilution coefficient D, according to the equation (6).

Di=ⁿ√D (n=the number of dilution channels) (6)

Thus, according to equations (5) and (6), in the example shown in FIG. 3, D1=D2=D.

Such an analysis device can therefore be configured for analyzing, on the one hand, a flow of gas at the input of a filter and, on the other hand, a flow of gas at the output of the filter. In fact, even though the concentrations of gas differ at the input and output of the filter, the input concentration being much lower than the output concentration, the same analysis device can provide both measurements.

As an alternative, such an analysis device can be configured for analyzing the gas contained in a transport enclosure for the conveying and atmospheric storage of semiconductor substrates. The analysis device can for example be part of a station for measuring the contamination of the enclosure and which is coupled with such an enclosure for the measurement.

In fact, in the processes for manufacturing semiconductors or electro-mechanical microsystems (MEMS), the substrates such as wafers and the masks are usually transported and/or stored between the stages of the process in a standardized transport and/or storage enclosure with lateral opening of the FOUP (Front Opening Unified Pod) type or with a bottom opening of the SMIF (Standard Mechanical Interface) type.

These transport and/or storage enclosures are at atmospheric pressure of air or nitrogen.

The gasses contained in the enclosure can be analyzed by a measuring station placed in a clean room, for example in order to form a control station or again an entrance/exit chamber for semiconductor manufacturing equipment, comprising an analysis device for monitoring the gaseous contamination of the substrates or again of the enclosures themselves.

Thus the analysis device previously described uses a method for analyzing gas in order to determine the concentration of the gas to be analyzed (FIG. 4).

This analysis method can comprise a preliminary step 100 in which the dilution coefficient D of one or more dilution channels is determined as a function of the maximum concentration value of the range of concentration of the flow of gas to be analyzed Q. The flow of gas to be analyzed Q is determined from this dilution coefficient D and from a flow of neutral gas Qi to be injected (equation (2)).

Then, during a step 110, a flow of gas to be analyzed Q is diluted according to the dilution coefficient D. In order to do this, in step 112 the predetermined flow of neutral gas Qi is injected and, in step 114, a flow of diluted gas Qp is pumped in order to maintain a substantially constant pressure. The pumped flow of diluted gas Qp is calculated from equation (3).

Then, in step 120, a diluted flow of gas Qa imposed by the analysis device 5 is sampled by pumping and then the sampled flow of diluted gas Qa is analyzed in step 130, for example by measuring the concentration Cm of the sampled flow of diluted gas Qa before determining, in step 140, the concentration C of the gas to be analyzed Q from the analyzed diluted flow of gas Qa and from the dilution coefficient D, for example by multiplying the measured concentration Cm by the dilution coefficient D.

It is therefore understood that such an analysis device with a diluting unit makes it possible to analyze a plurality of gasses having different ranges of concentration. Moreover, the dilution of the gas to be analyzed prevents risks of contamination and reduces the response time of the analysis unit.

1. A station for measuring gaseous contamination in a transport enclosure for semiconductor substrates comprising a gas analysis device for determining the concentration of the gas to be analyzed, said analysis device comprising:
a diluting unit (3) configured to dilute a flow of gas to be analyzed (Q) according to a dilution coefficient (D), and
an analysis unit (5) communicating with the diluting unit (3) via a sampling pipe (7) in order to sample a flow of diluted gas (Qa) by pumping, and comprising at least one processing means for:
analyzing the sampled flow of diluted gas (Qa), and
determining the concentration (C) of the flow of gas to be analyzed (Q) from said analyzed flow of diluted gas (Qa) and from the dilution coefficient (D).

2. The station for measuring gaseous contamination as claimed in claim 1, wherein the diluting unit (3) is connected as a branch with respect to said pipe (7).

3. The station for measuring gaseous contamination as claimed in claim 1, wherein the diluting unit (3) comprises a plurality of dilution channels (9a, 9b) connected as branches with respect to said pipe (7), each dilution channel (9a, 9b) being respectively associated with a dilution coefficient (D1, D2).

4. The station for measuring gaseous contamination as claimed in claim 3, wherein each dilution channel has:
a means of injection (11) of a flow of neutral gas (Qi) into said pipe (7) in order to dilute said flow of gas to be analyzed (Q), and
a means of pumping (13) a flow of diluted gas (Qp) in order to extract it from said pipe (7), in such a way as to maintain a constant flow in said pipe (7).

5. The station for measuring gaseous contamination as claimed in claim 3, wherein each dilution channel (9a, 9b) is respectively associated with the dilution of a flow of gas to be analyzed.

6. The station for measuring gaseous contamination as claimed in claim 3, wherein at least two dilution channels (9a, 9b) are associated for the dilution of a flow of gas to be analyzed.

7. The station for measuring gaseous contamination as claimed in claim 1, configured to analyze, on the one hand, a flow of gas at the input of a filter and, on the other hand, a flow of gas at the output of the filter.

8. A gas analysis method for determining the concentration of the gas to be analyzed comprising the following steps:
a dilution coefficient (D) is determined,
a predetermined flow of neutral gas (Qi) is injected and a flow of diluted gas (Qp) is pumped, in such a way as to dilute a flow of gas to be analyzed (Q),
a flow of diluted gas to be analyzed (Qa) is sampled by pumping,
the sampled flow of diluted gas (Qa) is analyzed,
the concentration (C) of the flow of gas to be analyzed (Q) is determined from said analyzed flow of diluted gas (Qa) and from the dilution coefficient (D).

9. The gas analysis method as claimed in claim 8, comprising a preliminary step in which the dilution coefficient (D) is determined as a function of the maximum value of concentration of the range of concentration of the gas to be analyzed.
